(19) United States
(12) Patent Application Publication
(10) Pub. No.: US 2019/0007218 A1
(43) Pub. Date: Jan. 3, 2019

(54) SECOND DYNAMIC AUTHENTICATION OF AN ELECTRONIC SIGNATURE USING A SECURE HARDWARE MODULE

(71) Applicant: BULL SAS, Les Clayes Sous Bois (FR)

(72) Inventors: Vincent KAHOUL, Villepreux (FR); Julien MARGINIER, Saint-Cyr-l'Ecole (FR); Anne BUTTIGHOFFER, Pradère-les-Bourguets (FR); Jean-Etienne SCHWARTZ, Villevêque (FR); Jean-Luc CHARDON, Les Clayes Sous Bois (FR)

(21) Appl. No.: 16/066,517

(22) PCT Filed: Dec. 26, 2016
(86) PCT No.: PCT/EP2016/082675

§ 371 Date: Jun. 27, 2018

(30) Foreign Application Priority Data
Dec. 28, 2015 (FR) 1563364

(51) Int. Cl. H04L 9/32; H04L 29/06

(52) U.S. Cl. CPC H04L 9/3247; H04L 63/0838; H04L 2463/082; H04L 9/3234; H04L 9/3263; H04L 9/3228

(57) ABSTRACT

A system for a second dynamic authentication of an electronic signature by a signing user of a document having signature keys located in a key container, using signer enrolment and signature applications connected to the server, wherein the system includes a secure hardware module to be connected to the signature server, including a system for building an activation challenge from a key identifier, and an initialisation password given by the signer, in order to issue the challenge to the signature server, which then requests a computing application to compute a one-time password to be sent to the signer.

This invention relates to a system for a second dynamic authentication of an electronic signature, comprising a secure hardware module, as well as a method for the dynamic authentication of a signature implementing such a system.

The development of means of electronic communication allows companies and administrations to propose a large number of on-line applications that give users the possibility to quickly access information systems and with a substantial flow rate, and to carry out data exchanges. These communications can be national or international.

However electronic exchanges require in certain cases an electronic signature that guarantees an identification and an authentication of the user with a level of security that is high enough to ensure a trust of the parties, by preventing the risks of incidents or malicious intent. These exchanges can concern confidential data of persons, companies or administrations. Financial must in particular provide this level of security.

The secure applications comprise a first authentication factor of the user allowing for the use of a private signature key, which can be immaterial such as a password, or material such as a USB key or a smart card. The user can be an individual or a machine.

The Council of the European Union in 2014 adopted a new regulation concerning electronic identification and trust services, called “e-IDAS” (Electronic identification, authentication and trust services), which imposes a second authentication factor in order to obtain electronic exchange certification.

During the carrying out of a signature it must be verified that the user that is applying this signature is indeed the one who is authenticated, in order to allow for the use of this private signature key. This check makes it possible to ensure the parties that a third-party cannot usurp the identity of the user. It also makes it possible to issue a signature that is non-repudiable, which provides legal security for the parties.

A known system of double authentication uses for the second authentication an “OTP” (one time password), issued by a hardware support also called a token.

During the request by the application of the second authentication, the user holding the hardware support carries out his connection with the application by entering a temporary code supplied by this support. This temporary code is established synchronously by a cryptographic technology.

The support hardware can be in particular a smart card, or a token, that is connected to a computer by a USB port. This system forms a so-called connected technology, that it is necessary to connected to a device which comprises disadvantages because it is not easy to transport.

In addition this system generates high costs that stem from the installation of software on the computers, the carrying out of hardware supports, the distributions thereof as well as maintenance.

Another known system of double authentication utilise a hardware support for the first authentication, and a code for the second. This is the case in particular of cash distributors at automatic bank withdrawal machines, which require after the insertion of a smart card the entry of a secret code. This system also generates substantial costs.

Another known system of double authentication uses for the second authentication a dynamic grid generated by the application following a particular coding that is renewed at each request, which is sent to the user. The user then enters his password on the grid, which carries out an encryption of this password.

This system which is used in particular by banks to secure orders passed over the Internet, poses in particular a problem of key entry by the signer of the password on the dynamic grid, which is not very simple. In addition it entails costs for creating and distributing dynamic grids.

Another known system of double authentication uses for the second authentication biometric data of the signer. This system which is already used for example in smartphones in order to unlock them, comprises a sensor that reads the fingerprints of a finger places thereon, in order to recognise them.

This system requires biometric reader hardware made available to each user, which generates substantial costs.

It is also possible to carry out a double authentication by using two passwords defined in succession in order to carry out the two authentications. However as the second password remains frozen it can be captured, for example with an attack or data theft. The reliability of the authentication is not very high.

Another known system of double authentication uses for the second authentication a one-time password OTP of the asynchronous type, generated after each first authentication, which is sent over the telephone of the user in the form of an “SMS” (short message service). This system is used in particular to secure banking orders.

Alternatively the one-time password OTP can be sent in other forms, and to any other type of peripheral device connected that makes it possible to receive it, such as a smartphone, tablet or a computer.

However in order to ensure the maximum level of security it is necessary that the generating, storing and verifying of the one-time password OTP allow for the use of the signature key of the user, be resistant to the various known types of attacks, comprising in particular sniffing, intercepting a communication between two parties “MITM” (man in the middle), exploiting a “buffer overflow”, a replay attack, data theft or the prediction of random numbers.

This latter known system using a one-time password OTP of the asynchronous type, generates by software or by hardware, is not suitable for the level of security requested as it defines the password thereof without specifying the means that secure the completeness of the protocol. In particular the current state of the art does not make it possible to authenticate a user with an application, and does not guarantee the impossibility of using the private signature key thereof by another means.

This invention in particular has for purpose to prevent these disadvantages of prior art, by carrying out for this double authentication system a connection between the user, the private signature key, and optionally, the document to be signed, in the framework of a protocol that guarantees the security of the transport of the one-time password OTP throughout the entire procedure, which suppresses in particular the possibilities of attack of the sniffing type, and of intercepting a communication between two parties MITM.

The invention proposes, for this purpose, a system for a second dynamic authentication of an electronic signature by a signing user of a document having signature keys located in a key container contained in a signature server; enrolment and signature applications being connected to this server. This system is remarkable in that it comprises a secure hardware module intended to be connected to the signature server, comprising means for building an activation challenge from a key identifier, and an initialisation password given by the signer, in order to issue said challenge to the signature server which then requests a computing application to compute a one-time password to be sent to the signer.

An advantage of this secure hardware system is that it constitutes an outside element that is highly secure that issues an activation challenge in order to obtain the second authentication, which is linked to both the signature key and to the initialisation password, which renders impossible any access to the key contained in the key container of the signer, without the activation of this module. A high level of security is as such obtained.

The invention can in addition comprise one or several of the following characteristics, which can be combined together.

Advantageously, the invention comprises a method for implementing a system for a second authentication, implementing a system comprising the characteristics hereinabove.

Advantageously, the method carries out a generating of the signature key comprising a step of transmitting by the signature server to the secure hardware module, a key identifier, a maximum use counter and an initialisation password, in order to obtain in return a pair of keys in the form of a user-linked key token and contained in the key container thereof, which is produced by this module.

Advantageously, the method carries out a request for a signature certificate associated with the signature key generated, comprising in succession a request to activate the signature key, the computing of a one-time password, and a signature request for the certificate request.

In this case, the request to activate a signature key can include a step of transmitting by the signature server to the secure hardware module, a key identifier that was issued by the signer, and an activation date, in order to obtain in return an activation challenge which is then issued to a computing application computing from this challenge a one-time password, then a step of transmission from the signature server to the secure hardware module, the key identifier, the one-time password and the signature certificate request, in order to obtain in return a signed certificate request demonstrating proof of possession of the key.

The method can then carry out a depositing of the signed certificate to a cryptographic key management infrastructure, in order to obtain a signature certificate issued to the signature server.

Advantageously, the method carries out with a signature application, an activation of the signature key of a document then a signature of this document.

In this case, the activation of the signature key of the document can comprise a step of transmitting by the signature server to the secure hardware module, the key identifier and the activation date, in order to obtain in return an activation challenge which is then issued to a computing application which computes a one-time password, then a step of transmitting this password to the signer, and then after the entry of this password by the signer and the transmission of the document to be signed, a step of transmitting by the signature server to the secure hardware module, the key identifier, the one-time password and a data hash to be signed computed from the document to be signed in order to obtain in return the signature of the data hash to be signed so as to allow the signature server to constitute the signed document.

The invention shall be better understood and other characteristics and advantages shall appear more clearly when reading the description hereinafter provided by way of example, in reference to the accompanying drawings wherein:

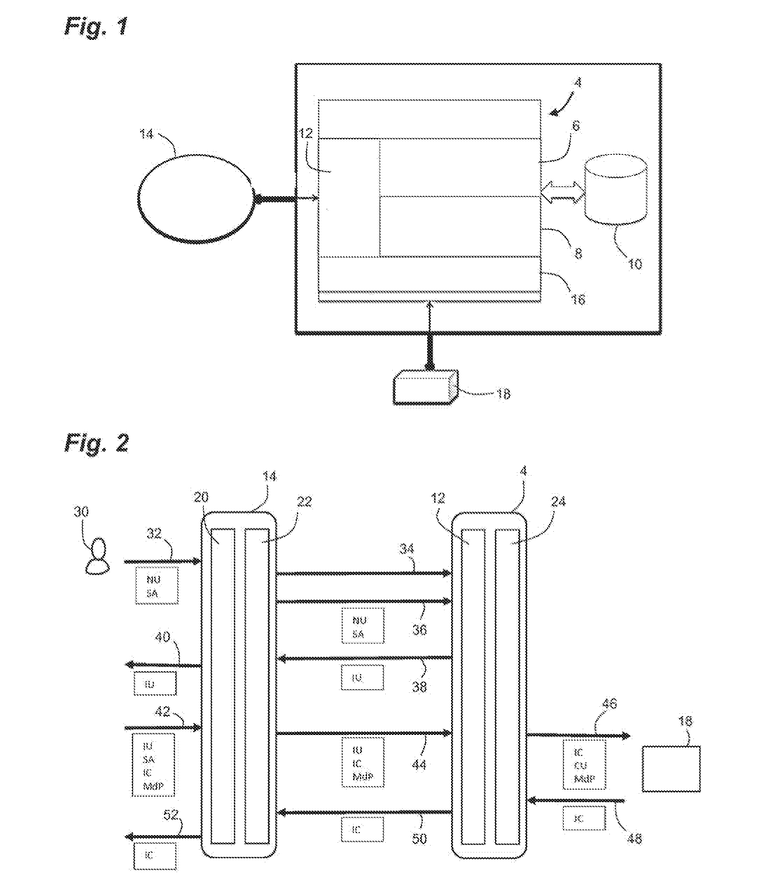

FIG. 1 shows the environment of a signature server using a system of a second authentication according to the invention;

FIGS. 2, 3 and 4 show three portions in succession of the method of enrolment of the signer by an enrolment application using the system of a second authentication; and

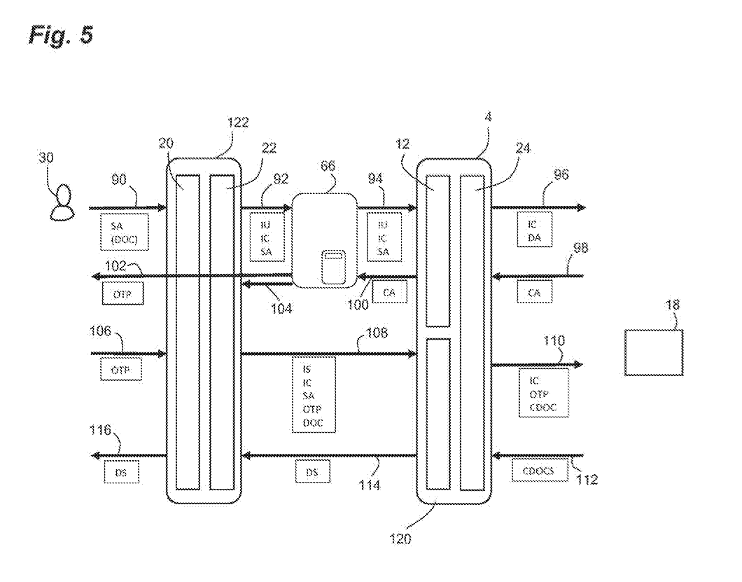

FIG. 5 shows the following part of the method comprising the signature of a document by a signature application.

FIG. 1 shows a signature server 4 comprising a signature server application having a signature module 6 and a user management module 8 that carries out exchanges with a database 10.

Generally the signature server application 4 comprises an “administrator” web service software 12, carrying out exchanges with an outside client enrolment application of the signer 14, and with an application for computing the one-time password OPT, and a “signature” web service software, carrying out exchanges with an outside client signature application.

These exchanges are carried out by the intermediary of a message transmission protocol between remote objects of the “SOAP” (Simple Object Access Protocol) type, which advantageously uses a secure hypertext transfer protocol of the “HTTPS” (HyperText Transfer Protocol Secure) type.

The signature server application 4 also comprises a software framework.

The signature server application 4 carries out exchanges with an outside secure hardware module 18 of the “HSM” (Hardware Security Module) type, by the intermediary of a cryptographic standard interface with a public key of the “PKCS” (Public Key Cryptography Standards) type, using in particular an Internet exchange secure protocol of the “SSL” (Secure Sockets Layer) type.

FIGS. 2, 3, 4 and 5 show on the left the enrolment application of the signer 14 or the signature application 122, which is the outside client application, comprising a user interface of the application 20 turned to the signer 30, and a communication module 22 with the signature server 4, using the message transmission protocol SOAP.

These figures show on the right the signature server 4 comprising the “administrator” “Web service” software 12, which exchanges with the communication module 22 of the enrolment application of the signer 14 or of the signature application 122, and a centralised interface 24 exchanging with the outside secure hardware module 18 HSM which is a device that is deemed to be inviolable providing cryptographic functions, able to generate, store and protect cryptographic keys.

The following steps shown in FIGS. 2, 3 and 4 are carried out in order to enroll in succession a signer and to generate a signature key, then activate this key in order to carry out a certificate request, and finally deposit the certificate obtained by a cryptographic key management infrastructure.

FIG. 2 shows the first portion of the method of registration or enrolment of the user or signer, which will create this signer and generate a signature key from an identifier.

The creation of the signer is carried out first, comprising the following steps.

In a first step 32, the signer 30 carries out an enrolment request, by giving to the enrolment application 14 this username NU, and an activation secret of his key container SA which is the first authentication factor. In a following step 34 the enrolment application 14 requests from the signature server 4 an opening of a session.

In a following step 36 the enrolment application 14 requests from the signature server 4 the creation of a user defining a key container in this server, dedicated for the signer 30, by sending it the username NU and the activation secret of the key container SA.

The key container defines a space in the signature server 4, dedicated to the user, containing data that can only be accessed by this user.

In return in the following step 38 the signature server 4 generates a user identifier IU sent to the enrolment application 14, then in a following step 40 this enrolment application transmits the user identifier IU to the signer 30.

In addition to this first portion the signer 30 can request several signature keys for the same container, in order to sign in a differentiated manner different documents contained in this container.

In a second portion of the method is carried out the generation of the signature key which will allow for the second authentication, carrying out the following steps.

In a first step 42 in order to obtain a key identifier IC and allow for access to the container, the signer 30 transmits to the enrolment application 14 the user identifier received IU, the activation secret of the key container SA, a key identifier IC, and an initialisation password of the key MdP which can be supplied by a trusted third-party application, so as to create the system of a second authentication factor which will be linked to the key.

In a following step 44 of generating the signature key, comprising a public portion and a private portion remaining hidden in the secure hardware module 18, the enrolment application 14 transmits to the signature server 4 the user identifier IU, the key identifier IC and the initialisation password of the key MdP.

In a following step 46 of generating the signature key, the signature server 4 transmits to the secure hardware module 18 the key identifier IC, a maximum use counter CU and the initialisation password MdP, in order to allow it to generate a signature key.

The secure hardware module 18 will use the initialisation password MdP in order to associate with the generating of the signature key a particular property that makes it possible to build a dynamic secret, also called a one-time password OTP, which is linked to the key and therefore to the user. In a following step 48 the secure hardware module 18 transmits to the signature server 4 a key token, associated with the user JC, forming a pair of keys also called two-key.

In a following step 50 the signature server 4 transmits the key identifier IC to the enrolment application 14, this application sends it in turn in a following step 52 to the user 30.

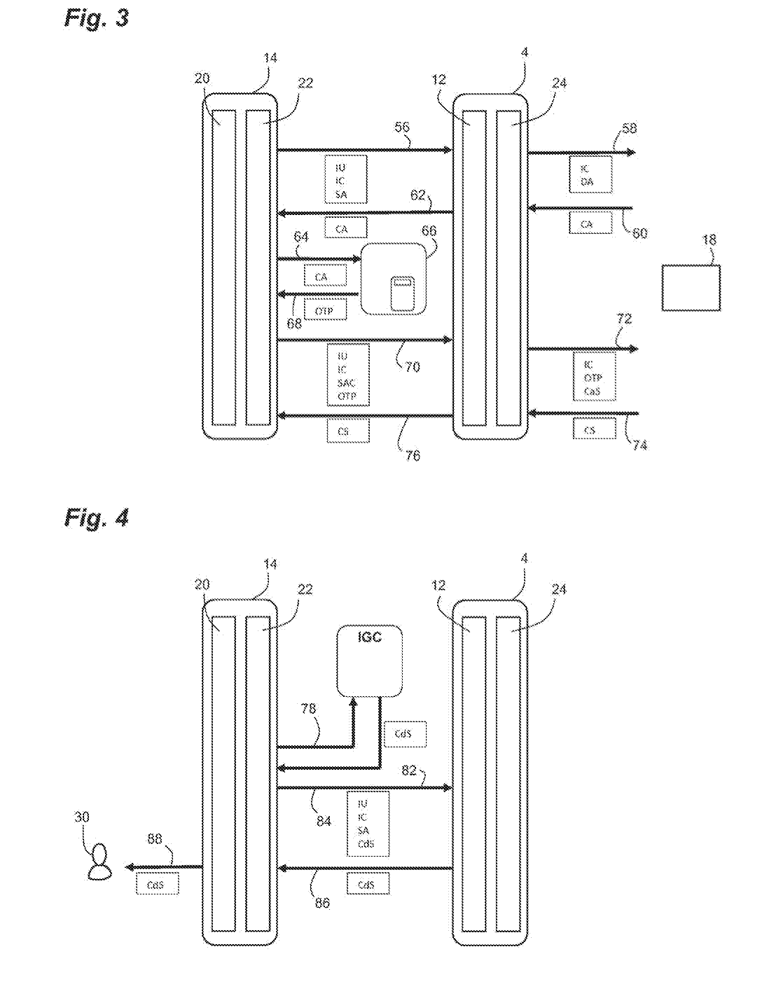

In a third portion of the method shown in FIG. 3, the certificate request that makes it possible to activate the signature key comprising the following steps is carried out.

FIG. 3 shows in a first step 56 the activation request of the signature key by the enrolment application 14 transmitting to the signature server 4 the activation request of the signature key, comprising the user identifier IU, the key identifier IC and the activation secret of the key container SA.

The signature server 4 transmits to the secure hardware module 18 the key identifier IC, and an activate date DA. The secure hardware module 18 then associates with the signature key an activation challenge CA which is calculated from the initialisation password MdP, and transmits it in a following step 60 to the signature server 4.

In a following step 62 the signature server 4 transmits to the enrolment application 14 the activation challenge CA, which transmits it in turn in a following step 64 to a computing application OTP 66 that computes from this challenge a dynamic activation secret which forms a one-time password OTP. In return in a following step 68 the computing application OTP 66 transmits to the enrolment application 14 the built one-time password OTP.

In a following step 70 the enrolment application 14 transmits to the signature server 4 a “CSR” (Certificate Signing Request), combined with the signature key, comprising the user identifier IU, the key identifier IC, the activation secret of the key container SA and built one-time password OTP.

The signature server 4 transmits in a following step 72 to the secure hardware module 18 this certificate signing request CSR, comprising the key identifier IC, the built one-time password OTP and the certificate request to be signed CaS. In return in a following step 74 the secure hardware module 18 transmits to the signature server 4 the signed certificate request CS, which is then transmitted in a following step 76 to the enrolment application 14.

In a fourth portion of the method shown in FIG. 4 is carried out the deposit of the certificate in the signature server 4, comprising the following steps.

In a first step 78 the enrolment application 14 transmits the certificate request to an outside cryptographic key management infrastructure “IGC” (Key Management Infrastructure).

In a following step 82 the key management infrastructure IGC issues to the enrolment application 14 a signature certificate CdS comprising public data combined with the signature key.

In a following step 84 the enrolment application 14 carries out a deposit of the certificate to the signature server 4, by transmitting to it the user identifier IU, the key identifier IC, the activation secret of the key container SA and the signature certificate CdS.

In particular the signature certificate CdS can be according to the X509 standard, which is a cryptographic standard of the International Telecommunications Union for public key infrastructures, establishing in particular a standard format for the electronic certificate and an algorithm for the validation of the certification path.

As an alternative the signature server can directly request from the key management infrastructure IGC the issuing of the certificate to the signature server 4.

The signature server 4 verifies at this time that the signature certificate received indeed corresponds to the private key of the signer, then in a following step 86 issues to the enrolment application 14 the information that the imported signature certificate CdS is available. In a following step 88 the enrolment application 14 presents to the signer 30 the signature key and the signature certificate CdS available.

In a fifth portion of the method shown in FIG. 5 is carried out the signature by the signer of documents in the signature server 4, comprising the following steps.

In a first step 90 for the signing of a document, the signer 30 issues to the signature application 122 the activation secret of the key container SA, and optionally the document to be signed DOC. Alternatively the document to be signed can be supplied in a later step.

For the activation request of the signature key, the signature application 122 then transmits in a following step 92 the user identifier IU, the key identifier IC and the activation secret SA to the computing application OTP 66, which in turn transmits these elements to the signature server 4 in a following step 94.

Then the signature server 4 carries out an activation request of the signature key, by transmitting via a following step 96 the key identifier IC and the activation date DA to the secure hardware module 18, which then establishes an activation challenge CA computed from the initialisation password MdP, and optionally from the hash of the document is the latter was supplied to it, in order to issue it in a following step 98 to the signature server.

Adding the document hash as information makes it possible to link the signature to this document only, which guarantees that the key will not be able to be used to sign other documents.

In a following step 100 the signature server 4 issues the activation challenge CA to the computing application OTP 66, which on the one hand in a following operation 102 sends to the signer 30 a message of the SMS type containing the built one-time password OTP, and on the other hand in a parallel operation 104 informs the signature application 122 of this sending.

Note that the computing application OTP 66 can issues its built one-time password OTP only if it receives the activation secret of the key container SA and the activation challenge CA. Without this latter piece of information coming from the secure hardware module 18, the one-time password OTP cannot be issued, which provides a good level of security.

Also note that the computing application OTP 66 does not transmit the one-time password OTP to the signature application 122, this application therefore cannot carry out the signature operation without intervention from the signer. In addition the signature application 122 cannot carry out any exchange with the signature server 4 by using the “administrator” web service 12 in order itself to request the activation of the key, which ensures a good level of security via partitioning of the permitted actions with this signature server.

In a following step 106 the signer 30 enters the built one-time password OTP on the signature application 122.

We then have the signing of the document comprising a following step 108 wherein the signature application 122 transmits to a “signature” web service software 120 of the signature server 4, the identifier of the signer IS, the identifier of the key IC, the activation secret of the key container SA, the built one-time password OTP and the document to be signed DOC.

We then have the signature of the hash of the data to be signed, comprised from the document to be signed, comprising a following step 110 wherein the signature server 4 transmits to the secure hardware module 18 the key identifier IC, the built one-time password OTP and a hash of the document to be signed CDOC. In return in a following step 112, the secure hardware module 18 sends to the signature server 4 the signature of the hash of the document to be signed CDOCS

In a following step 114 the “signature” web service software 120 of the signature server 4 transmits to the signature application 122 the signed document or the detached signature DS. In a last operation 116 the signature application 122 transmits to the signer 30 the signed document so that he can recover it.

Thanks to the secure hardware module 18 which can easily be connected to the signature server 4, an independent component is thus obtained that generates signature keys and keeps them with a level of security, and which can issue the signature of the data to be signed CDOCS only if it is given the correct built one-time password OTP. The signer and the private signature key are linked in this secure hardware module 18, not at the application level, which offers reinforced security on the use of this key.

The dynamic nature of the activation secret makes it possible to guarantee the uniqueness of the transactions, by suppressing the problem of replaying. In particular the means known in the prior art for generating one-time passwords OTP only make it possible to identify a user with an application, they do not guarantee against the use of this signature key by another means.

Note that the signature application 122 as well as the enrolment application 14 do not know the secure hardware module 18 which is an outside component, which makes it protected from an attack on these sets comprising software that can be forced more easily.

1. A system for a second dynamic authentication of an electronic signature by a signing user of a document having signature keys located in a key container, using signer enrolment and signature applications connected to the server, the system comprising a secure hardware module to be connected to the signature server, comprising means for building an activation challenge from a key identifier, and an initialisation password given by the signer, in order to issue said challenge to the signature server which then requests a computing application to compute a one-time password to be sent to the signer.

2. A method for implementing a system for a second dynamic authentication according to claim 1, comprising building an activation challenge from a key identifier and an initialisation password given by the signer.

3. The method for implementing according to claim 2, comprising generating a signature key comprising a step of transmitting by the signature server to the secure hardware module, a key identifier, a maximum use counter and an initialisation password, in order to obtain in return a pair of keys in the form of a user-linked key token and contained in the key container thereof, which is produced by the module.

4. The method for implementing according to claim 2, comprising carrying out a request for a signature certificate associated with the signature key generated, comprising in succession a request to activate the signature key, the computing of a one-time password, and a signature request for the certificate request.

5. The method for implementing according to claim 4, wherein the request to activate a signature key comprises a step of transmitting by the signature server to the secure hardware module, a key identifier that was issued by the signer, and an activation date, in order to obtain in return an activation challenge which is then issued to a computing application computing from the challenge a one-time password, then a step of transmitting from the signature server to the secure hardware module, the key identifier, the one-time password and the signature certificate request, in order to obtain in return a signed certificate request demonstrating proof of possession of the key.

6. The method for implementing according to claim 5, comprising carrying out a deposit of a signed certificate request at a encryption key management infrastructure, in order to obtain a signature certificate issued to the signature server.

7. The method for implementing according to claim 2, comprising carrying out a signature application, an activation of the signature key of a document then a signature of the document.

8. The method for implementing according to claim 7, wherein the activation of the signature key of the signer comprises a step of transmitting by the signature server to the secure hardware module, the key identifier and the activation date, in order to obtain in return an activation challenge which is then issued to a computing application which computes a one-time password, then a step of transmitting the password to the signer, and then after the entry of the password by the signer and the transmission of the document to be signed, a step of transmitting by the signature server to the secure hardware module, the key identifier, the one-time password, and a data hash to be signed computed from the document to be signed in order to obtain in return the signature of the data hash to be signed so as to allow the signature server to constitute the signed document.
